(19) United States
(12) Patent Application Publication
(10) Pub. No.: US 2012/0187044 A1
(43) Pub. Date: Jul. 26, 2012

(54) METHODS OF CLEANING MEMBRANE MODULES

(75) Inventors: Fufang Zha, West Ryde (AU); Huw Alexander Lazaredes, North Richmond (AU); Zhiyi Cao, Lidcombe (AU)

(73) Assignee: SIEMENS INDUSTRY, INC., Alpharetta, GA (US)

(21) Appl. No.: 13/436,219

(22) Filed: Mar. 30, 2012

Related U.S. Application Data
(63) Continuation of application No. 10/572,893, filed on Mar. 20, 2006, now abandoned.

(30) Foreign Application Priority Data
Sep. 19, 2003 (AU) 2003905139
Sep. 15, 2004 (AU) PCT/AU2004/001251

(51) Int. Cl. B01D 65/02

(52) U.S. Cl. 210/636

(57) ABSTRACT

A method and apparatus for backwashing a membrane filtration system wherein permeate remaining present in the filtration system wherein permeate remaining present in the filtration system when the filtration process is stopped or suspended is used to provide liquid for backwashing the membrane pores during a backwashing process.

### RELATED APPLICATIONS

This application is a continuation of U.S. application Ser. No. 10/572,893 filed on Mar. 20, 2006, titled METHODS OF CLEANING MEMBRANE MODULES, which is a U.S. national stage application and claims the benefit under 35 U.S.C. §371 of International Application No. PCT/AU2004/001251 filed on Sep. 15, 2004, titled IMPROVED METHOD OF CLEANING MEMBRANE MODULES, which claims priority to Australian Provisional Application Serial No. 2003905139, titled IMPROVED METHOD OF to CLEANING MEMBRANE MODULES, filed on Sep. 19, 2003, each of which is herein incorporated by reference in their entirety for all purposes and to which this application claims the benefit of priority.

### TECHNICAL FIELD

The present invention relates to membrane filtrations systems and more particularly to improved methods and apparatus for cleaning the membranes used in such systems.

### BACKGROUND OF THE INVENTION

Membrane cleaning is a key step to the success of any membrane filtration process. Without regular cleaning the membranes become clogged with impurities and eventually inoperative. Different physical membrane cleaning strategies have been proposed and published. A summary of some typical methods is described below.

1. Scrubbing membranes with gas bubbles. This method was first published by Yamamoto et al. (Water Science Technology, Vol. 2, pages 43-54; 1989) and has been widely used in the low-pressure filtration processes. The shear force created by gas bubbles removes fouling materials on the membrane surface, but does little to reduce the fouling in the membrane pores.

2. Backwash or back pulsing method. This method uses a reversed flow of fluid through the membrane pores to dislodge of fouling materials therefrom. Either gas or liquid can be used as a fluid in the reverse backwash.

In a PCT Published Application No. WO 03/059495, Bartels et al describe a backwash technique where the hollow fiber membranes are pressurized with a gas on a feed side at a specified time during the backwash. They describe the periodic use of such backwash to effectively remove fouling components from the hollow fiber membranes.

To carry out a liquid backwash, typically a liquid pump and a liquid holding tank are required. The pump delivers a permeate flow in a reverse direction to the normal filtration flow through the membrane pores to clean accumulated solids and impurities from the membranes pores. In a pressurized membrane filtration process, this requires more ancillaries. In a typical membrane filtration system, the membrane modules are connected to a manifold or other similar piping arrangement to provide for inflow of feed and removal of filtrate/permeate. At the end of filtration period, the membrane permeate side and the permeate manifold remain filled with permeate.

### DISCLOSURE OF THE INVENTION

The present invention seeks to make use of such permeate remaining in the manifold and in the membranes (membrane lumen or the vessel holding membranes and permeate in the case of inside-out filtration) as a source for liquid backwash.

According to one aspect, the present invention provides an improved method of backwashing a membrane filtration system including the step of using permeate remaining present in the system when the filtration process is stopped to provide liquid for backwashing the membrane pores during a backwashing process.

Preferably, a pressurized gas is employed to push the remaining permeate through the membrane pores during backwashing of the membranes.

Preferably, the pressure of the gas applied to the permeate should be less than the bubble point of the membrane so that the gas cannot penetrate into membrane pores.

According to another aspect the present invention provides a method of filtering solids from a liquid suspension comprising:

(i) providing a pressure differential across the walls of permeable, hollow membranes immersed in the liquid suspension, said liquid suspension being applied to the outer surface of the porous hollow membranes to induce and sustain filtration through the membrane walls wherein:
(a) some of the liquid suspension passes through the walls of the membranes to be drawn off as permeate from the hollow membrane lumens, and
(b) at least some of the solids are retained on or in the hollow membranes or otherwise as suspended solids within the liquid surrounding the membranes,

(ii) periodically backwashing the membrane pores using the permeate remaining within the lumens by applying a gas at a pressure below the bubble point to said liquid permeate to displace at least some of the liquid permeate within the lumens through the membrane pores resulting in removal of the solids retained on or in the hollow membranes. A method of filtering solids from a liquid suspension comprising:

(i) providing a pressure differential across the walls of permeable, hollow membranes having a liquid suspension applied to the inner surface of the permeable hollow membranes to induce and sustain filtration through the membrane walls wherein:
(a) some of the liquid suspension passes through the walls of the membranes to be drawn off as permeate from the outer surface of said membranes, and
(b) at least some of the solids are retained on or in the hollow membranes or otherwise as suspended solids within the membranes,

(ii) stopping or suspending the filtration process;

(iii) periodically backwashing the membrane pores using the permeate remaining after the suspension of the filtration process by applying a gas at a pressure below the bubble point to said liquid permeate to displace at least some of the liquid permeate through the membrane pores resulting in removal of the solids retained on or in the hollow membranes.

According to another aspect, the present invention provides a method of filtering solids from a liquid suspension in a filtration system comprising:

(i) providing a pressure differential across the walls of permeable, hollow membranes having a liquid suspension applied to the inner surface of the permeable hollow membranes to induce and sustain filtration through the membrane walls wherein:
(a) some of the liquid suspension passes through the walls of the membranes to be drawn off as permeate from the outer surface of said membranes, and
(b) at least some of the solids are retained on or in the hollow membranes or otherwise as suspended solids within the membranes,

(ii) stopping or suspending the filtration process;

(iii) periodically backwashing the membrane pores using the permeate remaining in the system after the suspension of the filtration process by applying a gas at a pressure below the bubble point to said liquid permeate to displace at least some of the liquid permeate through the membrane pores resulting in removal of the solids retained on or in the hollow membranes.

Preferably, during the backwashing step the solids are removed into the bulk liquid surrounding the membranes.

Preferably, permeate remaining in ancillaries such as manifolds, headers, piping and the like may also be used in addition to that in the membrane lumens as a source of backwash liquid. Where insufficient permeate volume for backwash is available from these sources, a further chamber or reservoir may be provided in the permeate flow circuit to increase the amount of permeate available for backwashing when filtration is suspended.

Where a number of the modules are used in a bank and connected to a manifold for distributing feed and removing permeate, the pressurized gas may be introduced into the manifold of the bank of modules so that the permeate in the manifold can also be utilized for backwash. In the case of a filtration process where permeate is taken from both ends of the membrane module, the gas pushed backwash can be selected to apply to the either end only of the membrane modules, or to both ends at the same time, depending on the requirement.

According to another aspect the present invention provides a filtration system for removing fine solids from a liquid suspension comprising:

(i) a vessel for containing said liquid suspension;

(ii) a plurality of permeable, hollow membranes within the vessel;

(iii) means for providing a pressure differential across walls of said membranes such that some of the liquid suspension passes through the walls of the membranes to be drawn off as permeate;

(iv) means for withdrawing permeate from the membranes; and

(v) means for applying gas at a pressure below the bubble point to the liquid permeate within the system and the membrane lumens to affect a discharge of at least some of the liquid permeate in the lumens through the membrane walls to dislodge any solids retained therein and displace the removed solids into the liquid suspension surrounding the membranes.

A general backwash procedure using the improved method may involve a number or all of the following steps.

Filtering-down of feed level within the feed vessel using aeration gas or other low pressure gas sources;

Scouring of membrane surfaces by flowing gas bubbles past the membrane surfaces;

Backwashing the membrane pores by flowing permeate remaining present in the system in a reverse direction to the normal filtration flow through the membrane pores;

Discharging of backwash waste by sweep, drain-down or by a feed and bleed process to partially discharge backwash waste;

Refilling the membrane vessel, venting gas on the permeate side and resuming filtration.

At the end of backwash cleaning, the concentrated backwash waste has to be discharged from the module. There are two common ways to discharge the backwash waste: drain down the concentrate from the vessel or sweep the vessel with the feed flow. During the sweep process, it is a common practice to pump the feed into the bottom of the membrane vessel and the plug flow sweeps out of the concentrate from the top of the vessel.

We have found that it is beneficial to inject gas, typically air, into the membrane vessel during part or whole of the sweeping period. The gas bubbles formed in the vessel by injection of gas enhance the sweeping effect and the backwash efficacy is thus improved.

According to another aspect, the present invention provides an improved method of cleaning a membrane filtration system including the step of providing gas or gas bubbles within the membrane vessel during the sweep or drain down of concentrate from the vessel during or following a backwashing, scouring and/or cleaning step.

The sweeping with aeration of concentrate from the vessel can be partially or fully integrated with the liquid backwash step (either a pumped liquid backwash or the gas pushed liquid backwash described above).

Drain-down by gravity is a common method of discharging backwash waste from the membrane vessel. Incomplete drain-down can result in poor backwash efficiency in that highly concentrated waste may remain in the vessel and immediately re-foul the membranes on recommencement of filtration. In a system using groups of modules, there normally exists a layer of liquid waste at the bottom of the vessel after drain-down. Several improved methods can be used to reduce the impact of the remaining waste on the filtration process.

1) Gas facilitated drain-down. At the end of backwash, continue injection of the scouring gas into the feed vessel while shutting off the gas vent valve. The pressure of the scouring gas helps to facilitate the drain down. Alternatively, a pressurized gas can be applied to the feed vessel on the feed side to facilitate the drain down.

2) Dilute backwash waste. During a typical backwash cycle, gas scouring starts to dislodge the fouling materials from the membrane surface. The solids in the vessel can be partly drained first prior to or during the liquid backwash of the membrane pores. Due to a reduced volume of waste in the vessel, the concentration of solids is then diluted after the liquid backwash as more clean permeate comes out to the feed side of the membrane modules. In the final drain stage, even if an incomplete drain-down occurs, the solid concentration within the vessel is diluted when the vessel is re-filled with fresh feed water.

3) Flush of waste at the bottom of the vessel. The remaining backwash waste at the bottom of the vessel can be flushed out by pumping the feed water rapidly through the vessel. The backwash waste can be flushed out to the discharge or to the feed inlet and mixed with the fresh feed.

### BRIEF DESCRIPTION OF THE DRAWINGS

Preferred embodiments of the invention will now be described, by way of example only, with reference to the accompanying drawings in which:

FIG. 1 is a schematic diagram of the six-module membrane filtration bank employing an embodiment of the invention;

FIG. 2 is a graph of transmembrane pressure (TMP) profile over time; and

FIG. 3 is a graph of resistance over time with and without air injection during the sweep step.

### PREFERRED EMBODIMENTS OF THE INVENTION

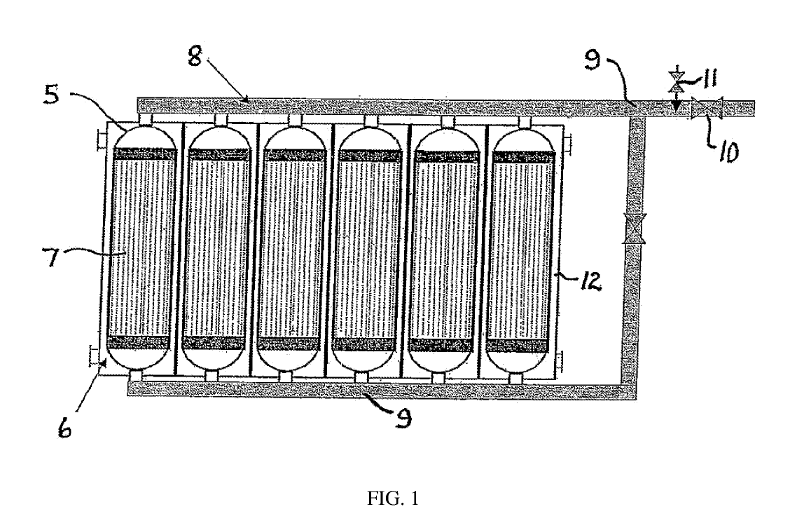

Referring to FIG. 1, the hollow fiber membrane modules 5 are mounted in the pressure vessels 6 and the filtration flow is from the shell side into the fiber lumens 7. Each of the modules 5 is connected to upper and lower manifolds 8 and 9. The upper manifold 8 is used to remove permeate withdrawn from the fiber lumens 7 during the filtration process. When the filtration process is suspended for a cleaning cycle, the manifold 8, associated piping 9 and lumens 7 remain filled with permeate. In this embodiment, a liquid backwash is achieved by closing valve 10 and applying a pressurised gas, at a pressure below the membrane bubble point, through valve 11 to the permeate to push the permeate remaining in the manifold 8 and fiber lumens 7 through the membrane pores to the shell side 12 and remove solids retained in the membrane pores.

In one example, the filtration unit was operated at filtration for 20 minutes and then switched to a backwash procedure. The backwash protocol was as follows:

Stop filtration and start gas scouring of the fiber membrane surfaces.

After gas scouring for 15 seconds, pressurised gas was applied through valve 11 to the permeate manifold 8 at a regulated pressure of around 2 bars to push the permeate in a reverse direction back through the membrane pores for 15 seconds.

Solids removed by the scouring and backwashing were then swept out of the modules 5 by pumping the feed water through the vessels for 25 seconds.

At the end of sweep, the gas pressure was released and filtration resumed

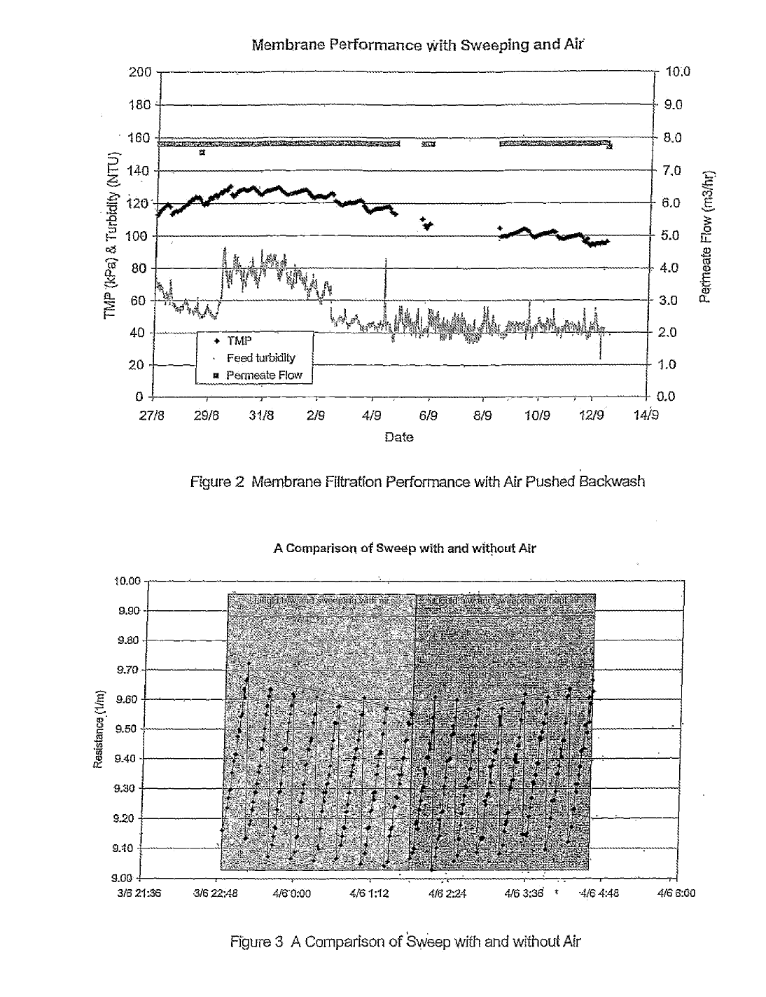

FIG. 2 shows the transmembrane pressure (TMP) profile over time with the above backwash strategy. The filtration performance was steady with a slight drop in transmembrane pressure (TMP) due to an improved feed water quality, indicating an effective backwash process.

In a further example, the effectiveness of employing air during the sweep was illustrated. In this example, eight cycles of sweeping solids from the vessel were carried out with gas being injected into the vessel and followed by the next eight cycles of sweeping without any gas injection. FIG. 3 shows the resistance change during the course of both forms of sweep. It is clear that the resistance of the membrane had a slight drop when air was injected during the sweep, but started to climb when no air was supplied during the sweep.

The methods and apparatus according to the embodiments of the invention desirably may include the following advantages but are not limited to

1) Eliminating the backwash pump and tank holding the permeate for backwash;

2) Use of a pressurized gas can easily achieve a short duration of “back-pulse” that cannot be economically achieved by means of a pump;

3) Reduced liquid backwash waste;

4) Low energy operation; and

5) Applying negative transmembrane pressure (TMP) is equivalent to applied gas pressure at all points of the membrane if the lumens are totally emptied of liquid.

It will be appreciated that further embodiments and exemplifications of the invention are possible without departing from the spirit or scope of the invention described.

1. A method of backwashing a membrane filtration system including a vessel, a membrane module, piping, and a manifold comprising:
filtering a feed liquid through pores in walls of membranes of the membrane filtration system to produce a liquid permeate;
withdrawing the permeate from lumens of the membranes and through the manifold, a portion of the piping, and a valve while filtering the feed liquid;
stopping the filtration process;
to isolating the lumens of the membranes, the manifold, the portion of the piping, and a gas inlet when the filtration process is stopped, the lumens of the membranes, the manifold, and the portion of piping upstream of the valve during filtration, wherein the lumens of the membranes, the manifold, and the portion of piping consist of those through which permeate is withdrawn while filtering the feed liquid;
scouring surfaces of the membranes by flowing bubbles of a first gas past surfaces of the membranes;
supplying a second gas through a second gas inlet at a pressure less than a bubble point of the membranes;
applying the second gas to a portion of liquid permeate present in the isolated lumens, manifold, and portion of piping by introducing the second gas through the second gas inlet into the filtration system on a side of the valve in direct fluid communication with the membrane module;
directing the portion of liquid permeate into the membrane module through a first end of the membrane module and through a second end of the membrane module;
backwashing the membranes by displacing at least some of the portion of liquid permeate through pores in walls of the membranes, the second gas not penetrating into the membrane pores;
discharging backwash waste from the vessel;
refilling the vessel with feed liquid;
venting the second gas from the isolated lumens, manifold, and portion of piping; and
resuming filtration.

2. The method of claim 1, wherein the permeate remaining present in the system when the filtration process is stopped consists of permeate present in the system on a side of a valve configured and arranged to isolate the filtration membranes from a second section of piping.

3. The method of claim 1, wherein isolating the membrane lumens, the manifold, and the gas inlet comprises closing the valve, the valve configured and arranged to to isolate the membranes from a second section of piping.

4. The method of claim 1, wherein backwashing is performed without the use of a backwash pump or a permeate holding tank.

5. The method of claim 1, wherein the permeate remaining present in the system when the filtration process is stopped consists of at least one of permeate remaining in at least one manifold in fluid communication with at least one membrane module, in at least one membrane module header, in piping associated with the at least one manifold and the at least one membrane module header, and in a permeate side of filtration membranes

6. The method of claim 1, further comprising draining down liquid suspension including the displaced backwashing liquid.

7. A method of filtering solids from a liquid suspension comprising:
immersing filtration membranes in the liquid suspension;
filtering the liquid suspension through pores in walls of the filtration membranes;
producing a liquid permeate within lumens of the filtration membranes;
drawing off liquid permeate from the lumens;
withdrawing the permeate from the lumens and through a manifold and a valve;
periodically suspending the filtration process;
isolating the lumens, the manifold, a gas inlet, and a portion of piping when the filtration process is suspended, the lumens, the manifold, and the portion of piping upstream of the valve during filtration, wherein the lumens, the manifold, and the portion of piping consist of those through which permeate is withdrawn;
directing liquid permeate present in the isolated manifold and portion of piping into the lumens through a first end of the filtration membranes and through a to second end of the filtration membranes; and
applying a gas at a pressure below a bubble point of the filtration membranes to the liquid permeate to displace at least some of the liquid permeate through the pores in the walls of the filtration membranes in a direction opposite to that of filtration, the gas not penetrating into the membrane pores.

8. The method of claim 7, wherein displacing at least some of the liquid permeate through the pores in the walls of the filtration membranes comprises removing solids from the filtration membranes into the liquid suspension surrounding the filtration membranes.

9. The method of claim 8, further comprising reducing the volume of the liquid suspension surrounding the filtration membranes before displacing at least some of the liquid permeate through the pores in the walls of the filtration membranes.

10. The method of claim 9, wherein the volume of liquid suspension surrounding the filtration membranes is reduced by suspending provision of the liquid suspension while providing a pressure differential across walls of the filtration membranes and drawing permeate from the filtration membranes.

11. The method of claim 8, further comprising removing at least part of the liquid suspension surrounding the filtration membranes containing the removed solids by a sweep, drain-down or by a feed and bleed process to at least partially discharge the liquid suspension surrounding the filtration membranes.

12. The method of claim 7, further comprising using permeate remaining in ancillaries such as headers, and piping in addition to that in the filtration membrane lumens and manifold as a source of backwash liquid.

13. The method of claim 7, further comprising increasing the amount of permeate available for backwashing when filtration is suspended by providing a further chamber or reservoir in a permeate flow circuit.

14. A method of filtering solids from a liquid suspension comprising:
applying the liquid suspension to lumens of filtration membranes;
filtering the liquid suspension through pores in walls of the filtration membranes;
forming liquid permeate on a shell side of a pressure vessel in which the filtration membranes are mounted;
drawing off liquid permeate from the shell side of the pressure vessel;
periodically suspending the filtration process; and
applying a gas at a pressure below a bubble point of the filtration membranes to liquid permeate remaining within the shell side of the pressure vessel, the liquid permeate remaining within the shell side of the pressure vessel consisting of the liquid permeate formed on the shell side of the pressure vessel, to displace at least some of the liquid permeate through the filtration membrane pores in a direction opposite to that of filtration, the gas not penetrating into the membrane pores.
